(19) United States
(12) Patent Application Publication
(10) Pub. No.: US 2022/0185410 A1
(43) Pub. Date: Jun. 16, 2022

(54) System, Method And Apparatus For Locking A Bicycle, A Scooter Or A Frame

(71) Applicant: Enova Design Pty Ltd, Croydon Hills (AU)

(72) Inventors: Marc Alexander, Croydon Hills (AU); James Murphy, Croydon Hills (AU)

(21) Appl. No.: 17/593,156

(22) PCT Filed: Mar. 12, 2020
(86) PCT No.: PCT/AU2020/050229

§ 371 Date: Sep. 10, 2021

(30) Foreign Application Priority Data
Mar. 12, 2019 (AU) 2019900809

(51) Int. Cl. B62H 5/00; E05B 47/00

(52) U.S. Cl. CPC B62H 5/003; E05B 47/0001

(57) ABSTRACT

An apparatus for locking a frame to an object, the apparatus including:
a tethering portion that is stored inside the frame, and that extends around the object when it is partially removed from inside the frame;
a retaining portion secured to a distal end of the tethering portion; and
a locking portion mounted inside the frame for receiving the retaining portion to lock the distal end of the tethering portion in the frame.

### TECHNICAL FIELD

The present disclosure relates to systems, methods and apparatuses for locking a bicycle, a scooter or a frame to an object.

### BACKGROUND

Various potentially valuable items have frames, for example scooters, bicycles, some skateboards, prams, golf carts, and luggage/wheeled bags. It is often desirable to lock such items to objects that are secured in place, e.g., rails or fences or bars or posts or trees, to resist undesirable removal of the item, e.g., theft of a bicycle or scooter, while the item is not in use.

Existing locks can be used to secure items to objects, e.g., bicycle D-locks or combination cable-locks; however, generally existing locks need to be purchased, carried and stored separately from the items, e.g., in a bag or attached to the frame by a custom clip, and such existing locks can be separated from the items and left behind, which in some circumstances may be undesirable.

It is desired to address or ameliorate one or more disadvantages or limitations associated with the prior art, or to at least provide a useful alternative.

### SUMMARY

According to the present invention there is provided an apparatus for locking a frame to an object, the apparatus including:
a tethering portion that is stored inside the frame, and that extends around the object when it is partially removed from inside the frame;
a retaining portion secured to a distal end of the tethering portion; and
a locking portion mounted inside the frame for receiving the retaining portion to lock the distal end of the tethering portion in the frame.

The invention also provides a system for locking a frame to an object, the system including:
a tethering portion that extends around the object;
a retaining portion secured to the tethering portion;
a locking portion that receives and locks the retaining portion; and
an electronic controller that unlocks the locking portion to release the retaining portion on receipt of an unlock message from an external controller that communicates wirelessly with the electronic controller, wherein the unlock message represents the external controller moving within a selected range of the electronic controller.

The invention also provides a method for locking a frame to an object, the method including:
tethering a tethering portion around the object; and
locking the tethering portion, further including:
   (a) storing the tethering portion in the frame; and
      locking the tethering portion in the frame,
      and/or
   (b) using an electronic controller; and
      unlocking the tethering portion on receipt of an unlock message from an external controller that communicates wirelessly with the electronic controller, wherein the unlock message represents the external controller moving within a selected range of the electronic controller.

The invention also provides method for manufacturing a locking apparatus, including:
forming a stopper tunnel in the frame to store a tethering portion;
forming an exit in the frame to draw the tethering portion around an object; and
forming an entrance in the frame to lock the tethering portion in the frame.

### BRIEF DESCRIPTION OF THE DRAWINGS

Some embodiments of the present invention are hereinafter described, by way of non-limiting example only, with reference to the accompanying drawings, in which:

FIG. 1 is a top view cross-sectional diagram of an apparatus for locking a bicycle, a scooter or a frame;

FIG. 2 is a top view cross-sectional diagram of a locking portion and a retaining portion of the apparatus;

FIG. 3A is a side view diagram of a tethering portion and the retaining portion of the apparatus;

FIG. 3B is a side view diagram of the tethering portion and a stopper portion of the apparatus;

FIG. 4 is a rear view cross-sectional diagram of the apparatus including a stopper tunnel for the stopper portion;

FIG. 5 is a left-upper-rear view diagram of the apparatus including handlebars of a frame;

FIG. 6 is a left-upper-rear view diagram of the apparatus including a scooter; and

FIG. 7 is a block diagram of a system including the apparatus and an external controller.

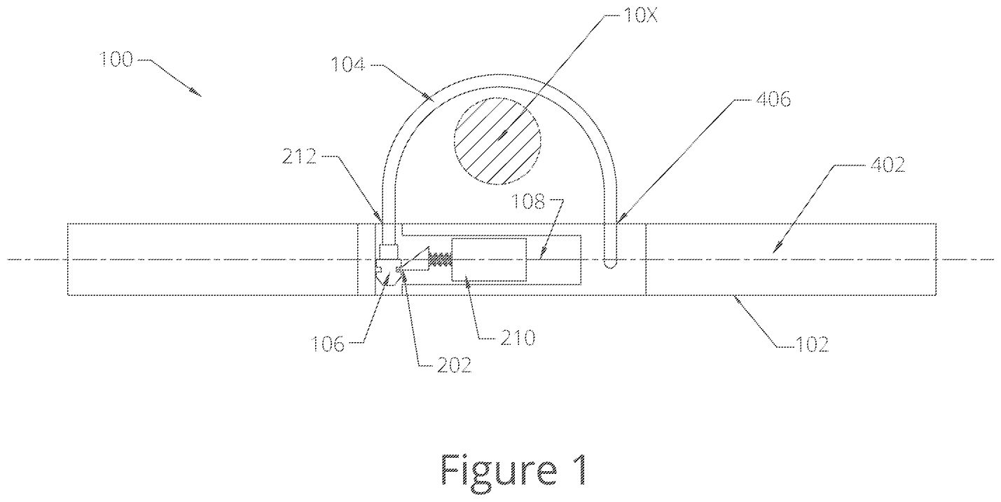

### DETAILED DESCRIPTION

Described herein is an apparatus (100) for locking a frame (102) to an object (10X), the apparatus (100) including: a tethering portion (104) that is stored inside the frame (102) in a storage position, and that extends around the object when it is partially removed from inside the frame (102); a retaining portion (106) secured to a distal end (302) of the tethering portion (104); and a lockset or locking portion (200) mounted inside the frame for receiving the retaining portion (106) to lock the distal end (302) of the tethering portion (104) to the frame (102).

The apparatus (100) may be referred to as “an integrated locking system” because the tethering portion (104), the retaining portion (106) and the locking portion (200) are integrated into the frame (102), and operate as components of the system that locks the item to the object. The apparatus (100) includes a case, housing or body that holds its components fixedly relative to each other in the frame (100). The case can be formed by portions of the frame (100) itself, i.e., by arranging and mounting the components of the apparatus (100) in the frame (100).

The tethering portion (104), which may be referred to as a “tether” or “shackle”, is a member that is rigid in tension and flexible in compression, such as a rope, cable, chain or linked arms (i.e., rigid arms linked by hinges). The tethering portion (104) resists separation and cutting so it cannot be broken using average manual strength, manual application of a knife or scissors, and/or manually operated bolt cutters. The tethering portion (104) can have a tensile strength and cut resistance equal to a commercially available bicycle cable lock, e.g., from ABUS, Kryptonite or OnGuard.

The tethering portion (104) includes an inner portion surrounded circumferentially by an outer portion. The inner portion resists manual separation of cutting, and can include steel cables, braided steel cable, steel links, jointed steel tube sections, etc. The outer portion, which may be referred to as a “cover”, protects the inner portion and assists the tethering portion (104) sliding into and out of the frame (102). The outer portion forms an outer circumference of the tethering portion (104) and can include a low-friction material to assist the tethering portion (104) sliding in and out of the frame (102), and a water resistant material and/or an ultra-violet (UV) resistant material to protect the inner portion from damage caused by contact with water and/or UV radiation. The outer portion can include a polymer material, including polyurethane or vinyl. The outer portion can be over moulded or heat-shrunk onto the inner portion.

The retaining portion (106) is fixed to the tethering portion (104) securely to resist at least manual separation of the tethering portion (104) from the retaining portion (106), e.g., equal to a commercially available bicycle cable lock.

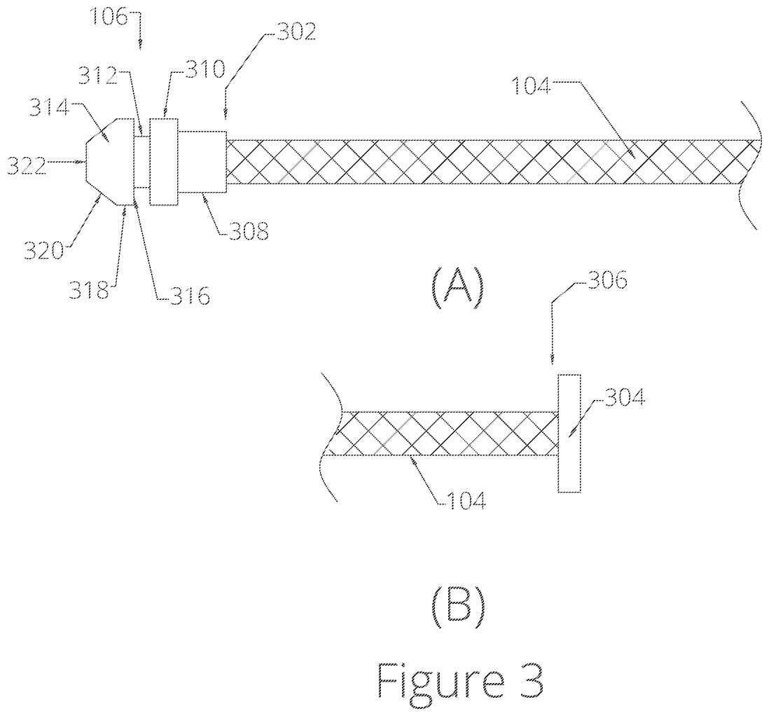

The retaining portion (106), which may be referred to as a “retainer”, “retainer lug” or “toe”, may be rotationally symmetric so it can be inserted into the locking portion (200) at any angle with equal effect. As shown in FIG. 3A, the retaining portion (106) includes a plurality of components, each of which is circularly symmetric and coaxially aligned.

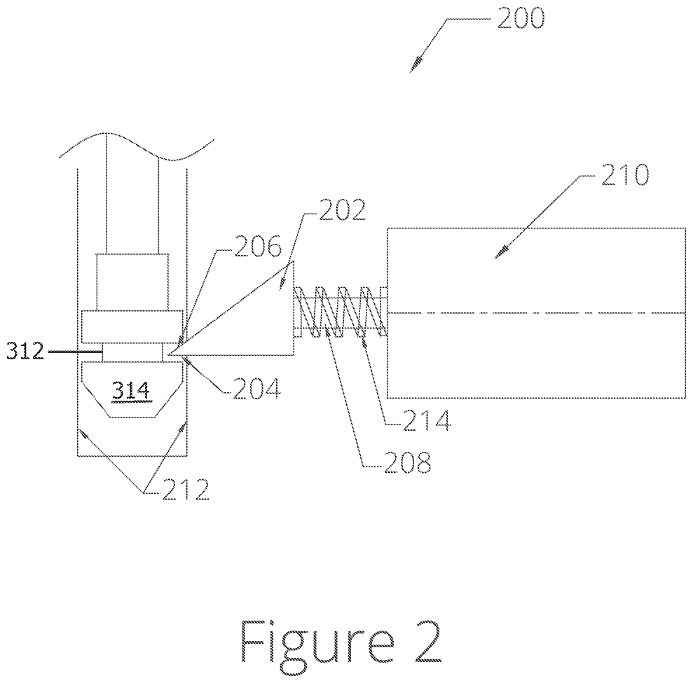

The components of the retaining portion (106) include:
a. a gripping portion (308) that grips onto the tethering portion (104), specifically the distal end (302) of the tethering portion (104) to provide secure resistance to manual separation of the tethering portion (104) from the retaining portion (106)—the gripping portion (308) can be fastened to the distal end (302) of the tethering portion (104) by clamping, crimping (e.g., using a 6-tooth hydraulic crimper), screwing, welding and/or brazing to provide the secure connection;
b. a slot (312) for receiving a latch bolt (202) of the locking portion (200), as shown in FIG. 2;
c. a retainer head (314), with a larger circumference than the slot (312), that pushes against the latch bolt (202) when in the slot (312), as shown in FIG. 2, to lock or secure the retaining portion (106) to the locking portion (200); and
d. a collar portion (310) that is coaxially aligned with the retainer head (314) for guiding the retaining portion (106) along inside an entrance (212) into the frame (102), and aligning the retaining portion (106) with a longitudinal axis of the entrance (212).

The components of the retaining portion (106) are arranged mutually coaxially and coaxially with the distal end (302) of the tethering portion (104), and are mutually securely connected, for example, the components of the retaining portion (106) can be formed as one piece, e.g., machined from a solid piece (e.g., by lathe), or formed in a mould, or printed, using suitably hard materials.

As shown in FIG. 3A, the retaining head (314) includes a retainer face (316) that is perpendicular to the longitudinal axis of the retaining portion (106), and that is parallel to and that presses against a latch face (204) of the latch bolt (202) when in the locking condition to secure and retain the retaining portion (106) in the locking portion (200). The retaining head (314) includes an enlarged portion (318) that is only slightly narrower than the entrance (212) and that provides the retainer face (316) being of a larger diameter than the slot (312).

The collar portion (310), which may be referred to as a “collar” or “retainer collar”, is only slightly narrower than the entrance (212) and thus at least mutually opposed sides of the collar portion (310) bear against mutually opposed sides of the entrance (212) to keep the longitudinal axis of the retaining portion (106) parallel with the longitudinal axis of the entrance (212), thus resisting twisting of the retaining portion (106), which might otherwise allow the retaining portion (106) to be pulled away from the latch bolt (202) even when in a locked condition. The enlarged portion (318) can have a diameter equal to the diameter of the collar portion (310) to also bear against the sides of the entrance (212) to mitigate the twisting.

The latch bolt (202) may be referred to as a “lock plate” or “latch bearing”. The latch bolt (202) may have a wedge shape as shown in FIG. 2. Alternatively, the latch bolt (202) may be a ball bearing with a ball shape that projects at least half-way into the entrance (212) so that force applied by the retainer face (316) to the ball bearing does not force the ball bearing back against the spring (208), i.e., out of the slot (312).

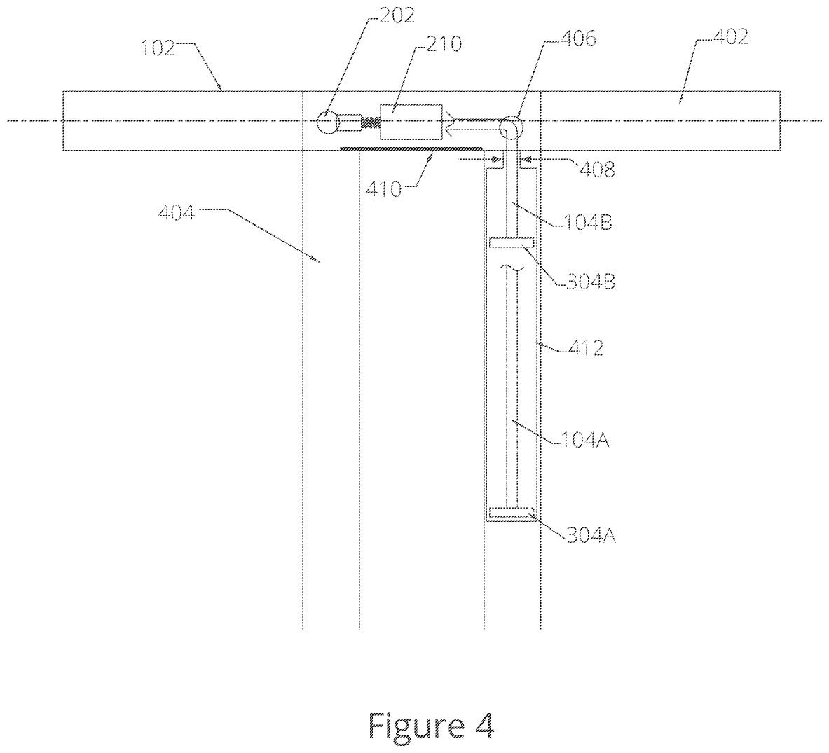

As shown in FIG. 4, the tethering portion (104) fits inside the frame (102) in a storage location (104A) when it is stored. The frame (102) includes one or more hollow portions for receiving the tethering portion (104) in the storage location (104A), e.g., handlebars and/or stem post of a scooter or bicycle, or a top tube, a seat post and/or a downtube of a bicycle. Thus, the storage location (104A) may be in a handlebar (402) and/or a stem (404) of the frame (102). The hollow portions can include a stopper tunnel (412) in the stem (404) as shown in FIG. 4.

The tethering portion (104) is longitudinally extended with a generally consistent cross-section to allow it to be drawn out of and fed into the frame (102) before and after use.

As shown in FIG. 3B, the apparatus (100) includes a stopper portion (304) at a proximal end (306) of the tethering portion (104) for attaching the proximal end (306) of the tethering portion (104) to the frame (102).

The stopper portion (304), which may be referred to as a “stopper” or “shackle heel”, is secured to the tethering portion (104) to resist manual separation of the stopper portion (304) from the tethering portion (104)—including by clamping, crimping (e.g., using a 6-tooth hydraulic crimper), screwing, welding and/or brazing—to provide this secure connection at least as strongly as the gripping portion (308) is fastened to the tethering portion (104).

The stopper portion (304) slides in the frame (102) in the stopper tunnel (412) formed in the frame (102). The stopper tunnel (412) may be formed by drilling a hole into or through and along a member of the frame (102), e.g., the stem (404) which may be formed of aluminium. The stopper portion (304) has a cross-sectional width (e.g., diameter), transverse to the longitudinal axis of the tethering portion (104) attached thereto, slightly less than the cross-sectional width of the stopper tunnel (412) so the stopper portion (304) slides in the stopper tunnel (412) without rattling between opposed sides of the stopper tunnel (412), thus reducing an undesirable source of noise or rattle while the item is being used in the unlocked condition. The stopper portion (304) can include a coating or circumferential material around the cross-sectional circumference that is: (i) low-friction to reduce sliding friction along the stopper tunnel (412); and (ii) resilient to reduce the rattle between the opposed sides of the stopper tunnel (412).

As shown in FIG. 4, the stopper portion (304) moves from a storage position (304A)—also referred to as a fully retracted position or a “stored position” or “stored condition”, when the tethering portion (104) is stored, to an extended position (304B) or “extended condition” when the tethering portion (104) is only partially stored inside the frame (102) and is at least partially outside the frame (102). As the tethering portion (104) is removed from inside the frame (102), the stopper portion (304) is pulled along inside the frame (102)—along the stopper tunnel (412)—towards a restriction hole (408) at an exit end of the stopper tunnel (412). The restriction hole (408) allows smooth passage of the tethering portion (104) therethrough while resisting, stopping and blocking the stopper portion (304). The restriction hole (408) has a cross-section that is larger than the cross-section of the tethering portion (104) and smaller than a cross-section of the stopper portion (304). The restriction hole (408) thus resists passage of the stopper portion (304) there through at least as strongly as the stopper portion (304) is secured to the tethering portion (104), e.g., resisting 5 kN or more than 1 kN, 2 kN, 3 kN, 4 kN, 5 kN, 6 kN, 7 kN, 8 kN, 9 kN or 10 kN, or at least as much as a commercially available bicycle cable lock.

The stopper tunnel (412) may be in an upright receiving portion of the frame (102) that receives the stopper portion (304) and the proximal end (306) of the tethering portion (104), and that, when in normal use, lies beneath the restriction hole (408) and an exit (406) from the frame (102), so that the stopper portion (304) is accelerated into the frame (102) away from the exit (304) by gravity. This may naturally assist with replacement of the tether portion (104) into the frame (102) after use as a lock. Alternatively or additionally, the apparatus (100) can include a retracting spring that is in tension when the tethering portion (104) is in the extended position (304B), and that is attached to the tethering portion (104) or the stopper portion (304), that naturally forces the tether portion (104) back into the frame (102) through the exit (406). For a scooter, the upright receiving portion can be the head stem post(s), and for a bicycle the upper receiving portion can be the seat post, head stem, seat tube or down tube. For a pram, a golf cart, or a roller luggage bag, the upright receiving portion can be the tube(s) reaching close to 1 m from the ground in the item's upright orientation.

The retaining head (312) includes a camming face (320) at an angle of 45 degrees (or between 25 degrees and 75 degrees) to the longitudinal axis of the retaining portion (106), thus forming a frustoconical section, that cooperates with an angled face (206) of the latch bolt (202) when the retaining portion (106) is pushed into the locking portion (200) to force the latch bolt (202) away from the longitudinal axis of the retaining portion (106) and out of the entrance (212), and thus around the enlarged portion (318) into the slot (312). The retaining portion (106) includes a front face (322) that effectively removes the otherwise pointed tip of the frustoconical section to remove a potentially sharp portion of the retaining portion (106) and a potentially brittle portion that might become damaged.

As shown in FIG. 2, the locking portion (200) includes a latch bolt (202) with the latch face (204) and the angle face (206). The locking portion (200) may be referred to as a “lockset”. The locking portion (200) includes a post (208) that extends from the latch bolt (202) into an actuator (210) of the locking portion (200). The post (208) moves into and out of the actuator bracket (210) along its longitudinal axis, thereby extending the latch bolt (202) into an entrance (202) of the locking portion (200), and retracting the latch bolt (202) from the entrance (212). The locking portion (200) includes a spring (214) that is axially aligned with the post (208), and can be mounted around the post (208) as shown in FIG. 2. The spring (214), which may be referred to as a “solenoid spring”, “actuator spring” or “lock spring”, is in compression, and thus naturally forces the latch bolt (202) into the entrance (212) so the angled face (206) and the latch face (204) are exposed in the entrance (212) for interference with the retaining portion (106) when it is in the entrance (212). In a natural, unpowered condition, the spring (214) pushes the latch bolt (212) into the entrance (212), thus extending the post (208) from the actuator (210) at least until the post (208) and/or the latch bolt (202) are stopped in their natural movement towards and into the entrance (212) by a buffer or catch, which may be formed in the entrance (212), e.g., as a slot in a side of the entrance (212) that is perpendicular to the longitudinal axis of the post (208), which is the same as the axis of the latch bolt (202), or an internal aperture or internal post of the actuator (210). To open the locking portion (200), the actuator (210) is actuated, i.e., “powered”, “activated” electrically or “electrified”, to power a pulling mechanism inside the actuator (210) that pulls the post (208) against the natural resilience of the spring (214) into the actuator (210). The pulling mechanism is an electromechanical transducer that converts electrical energy into a pulling force on the latch bolt (202) and the post (208). The electromechanical transducer can include an electromagnet (i.e., a solenoid) and cooperating magnetic or ferromagnetic portions attached to the post (208) and a body of the actuator (210). Alternatively, the electromechanical transducer can include a servo motor, a stepper motor or a DC motor attached to a screw mechanism that pulls the post (208). The spring (214) may be a commercially available spring that applies at least 1 N of force.

The entrance (212) is a channel, tunnel or tube into which the retaining portion (106) is inserted. The entrance (212) is inside the frame (102), either formed in the frame (102)—e.g., by drilling a hole into a solid member of the frame (102), which may be formed of aluminium, or as a separate portion inserted and mounted into or to the frame (102), thus when the retaining portion (106) is in the entrance (212), it is also in the frame (102). The entrance (212) includes one or more sides along which the retaining portion (106) moves, i.e., that are parallel to the retaining portion (106) when it is inside the entrance (212), and the sides hold the retaining portion (106) coaxially with the entrance (212), or at least guide the retaining portion (106) to and against and past the latch bolt (202) when the retaining portion (106) is inserted into the entrance (212), and that retain the retainer base (316) against the latch face (214) when in the locked condition, i.e., the entrance (212) is only slightly wider than the width of the enlarged portion (318) of the retainer head (314) so the retaining head bracket (314) cannot slip past the latch bolt (202) without interfering therewith along the longitudinal axis of the entrance (212).

The apparatus (100) includes electrical wiring (108) that connects the actuator (210) to energy storage on or in the item, e.g., a battery mounted on or in the frame (102), e.g., a commercially available battery for powering the actuator (210). The wiring (108) includes electrical conductors for carrying the power and electrical insulators coating the conductors that resist corrosion of the conductors and that avoid undesirable electrical connections between the frame (102) and the wiring (108). The wiring (108) can include 3 separate conductors securely concealed and held within the frame (102).

The components of the locking portion (200) can be mounted and aligned in the frame (102) either individually, i.e., while the relevant frame portion is being constructed, or as a separate stand-alone unit that is then separately mounted in or to the frame (102) and connected to the wiring (108). The frame (102) includes an opening in the frame (102) to receive the locking portion (200), typically facing downwards. The locking portion (200) is mounted into the opening by adhesion, mechanical fasters (e.g., screws or clips), welding and/or brazing. The opening is covered by a tamper-resistant cover (410), shown on an underside of the handlebars (402) in FIG. 4.

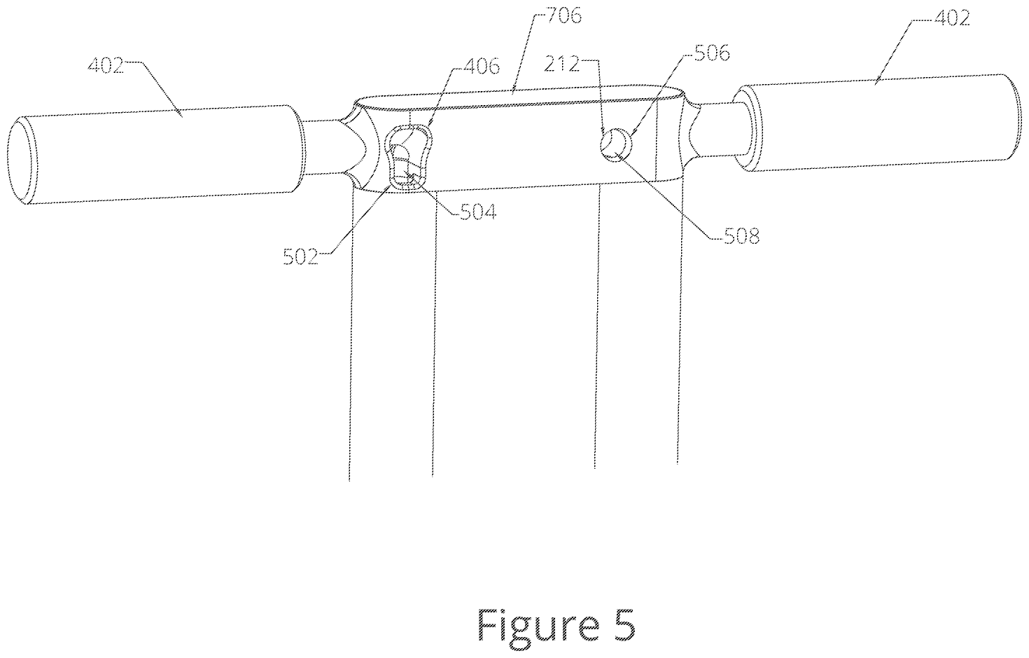

As shown in FIG. 5, the exit (406) can include an exit aperture (502) in the outer face of the frame (102), and an exit tunnel (504) projecting into the frame (102). The exit aperture (502) can have an irregular shape, for example a fattened “T” shape with a horizontally wide upper portion and a horizontally narrow lower portion that is sized to loosely receive the retaining portion (106) in a vertical orientation, i.e., aligned axially with the stopper tunnel (412), entirely within faces of the frame (102). When the stopper portion (304) is in the storage position (304A), the tethering portion (104) is entirely within the frame (102) in the stopper tunnel (412), and the distal end (302) of the tethering portion (104) is at the restriction hole (408) at a top (or exit end) of the stopper tunnel (412) held in the fully retracted position by the retaining portion (106) pressing against an outer side of the restriction hole (408). The restriction hole (408) is inside the frame, oriented vertically, so that a base of the retaining portion (106)—which can be the proximal face of the collar portion (310)—bears against an upward facing outer side of the restriction hole (408) when the tethering portion (104) is in the fully retracted position. Thus, in the fully retracted position, the retaining portion (106) naturally sits upright, i.e., with the front face (322) facing upwards, inside the exit tunnel (504). The exit tunnel (504) thus provides a storage alcove for the retaining portion (106) in its (upright) storage condition. The exit aperture (502) is sized to allow the retaining portion (106) to pass completely into and out of the exit tunnel (504), and to allow a user's fingers to reach into the exit tunnel (504) to grip a distal end of the retaining portion (106)—i.e., generally the retainer head (314)—to manually pull the retaining portion (106) out from the exit aperture (502) for use in locking. In other words, the upper portion of the fattened “T” is wide enough to receive one or two fingers adjacent to the distal end of the retaining portion (106) in its storage condition.

As mentioned hereinbefore, the stopper tunnel (412) is generally or at least partially vertical when the frame (102) is in a natural orientation, thus causing the tethering portion (104) to be naturally drawn back into the frame (102) by the force of gravity. The exit tunnel (504) includes a ninety-degree bend between the exit aperture (502) and the restriction hole (408) at the end of the stopper tunnel (412).

The exit aperture (502) is generally arranged in a portion of the frame (102) that is normally vertical so the frame (102) can be placed next to the object for securing thereto, and so the tethering portion (104) can easily reach the object as it exits the exit aperture (502). Rain is less likely to enter the exit aperture (502) due to its generally vertical orientation when the frame (102) is in its natural orientation.

As shown in FIG. 5, the entrance (312) includes an entrance aperture (506) formed in the face of the frame (102) that receives the retaining portion (106) into the frame (102), and thus into the entrance (212). The entrance (212) includes an entrance tunnel (508) that extends perpendicular to the face of the frame (102) and perpendicular to the entrance aperture (506) into the locking portion (200). The entrance aperture (506) and the entrance tunnel (508) can have the same cross-sectional shape as the cross-sectional shape of the retaining portion (106), which can be circular, and the size of the entrance aperture (506), e.g., the diameter, is slightly larger than the cross-sectional size of the retaining portion (106).

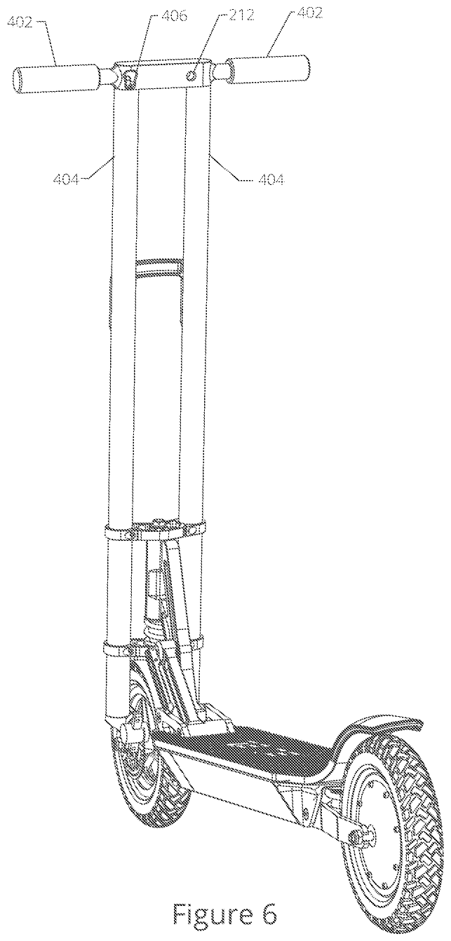

As shown in FIG. 6, the exit (406) and the entrance (212) can be formed in an upper portion of the frame (212), e.g., in the handlebars (402) and/or the L portion of the stem (404) thus allowing manual operation of the lock without needing to bend or squat excessively.

In embodiments, the tethering portion (104) can have a length of 500 mm or 600 mm, e.g., depending on the size of the frame (102) and length of the stem (404), or between 300 mm and 700 mm, or between 100 mm and 1 m. The tethering portion (104) can have a cross-sectional width (i.e., diameter) of 10 mm, or 10 mm to 12 mm, or between 2 mm and 15 mm depending on the application. The retaining portion (106) can have a maximum cross-sectional width (i.e., diameter of the enlarged portion (318) and the collar portion (310)) of 14 mm or 15 mm, or between 6 mm and 19 mm, or at least 4 mm larger than the cross-sectional width of the tethering portion (104). The stopper portion (304) can have a cross-sectional width (e.g., diameter), transverse to the longitudinal axis of the tethering portion (104) attached thereto, equal or substantially equal to the cross-sectional width of the retaining portion (106), or about 14 mm to 15 mm, or between 6 mm and 19 mm, or about 27 to 28 mm, or at least 4 mm larger than the cross-sectional width of the tethering portion (104) and at least 1 mm or 2 mm less than the cross-sectional width of the stopper tunnel (412). The restriction hole (408) can have a cross-sectional width between 1 mm and 3 mm more than the cross-sectional width of the tethering portion (104), and between 1 mm and 3 mm less than the cross-sectional width of the retaining portion (106) and of the stopper portion (304). The stopper tunnel (412) can have a cross-sectional width of about 28 mm, e.g., in a stem of about 32 mm diameter. The actuator (210) can have a cross-sectional width (diameter) of about 20 mm to 25 mm, and can be up to 40 to 50 mm in length. The spring (214) can be about 10 to 15 mm long when mounted to the post (208).

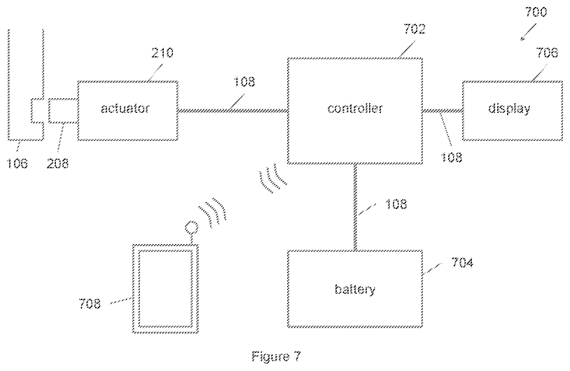

As shown in FIG. 7, the apparatus (100) includes the actuator (210) electrically connected by the wiring (108) to an electronic controller (702) that controls the actuator (210) by the wiring (108). The electronic controller (702) is attached to and/or mounted within the frame (102), e.g., attached to or mounted within the locking portion (200), so may be referred to as an “integrated electronic controller”. The apparatus (100) includes a battery (704) or electrical storage electrically connected to the controller (702) by the wiring (108). The apparatus (100) includes a display (706) connected to the controller (702) by the wiring (108). The display (706) may be mounted in the frame (102) to form a face of the frame (102), which may be an upper face of the handle bars (402) as shown in FIG. 5. The actuator (210), the controller (702), the battery (704), the display (706) and the wiring (108) form an electrical system of the apparatus (100) that receives electronic signals to control the actuator (210) to activate and de-activate the locking portion (200), i.e., to switch it between the locked state and the unlocked state.

The controller (702) can be a commercially available electronic controller unit, including an electronic microprocessor, a power controller, and an internal wireless communications module, with bespoke software and/or firmware settings to provide operational functions described herein. The controller (702), and its components, is powered electrically by the battery (704). The controller (702) controls the state of the actuator (210) based on signals received by the internal wireless communications module. The internal wireless communications module can be a Bluetooth module, including a low-power Bluetooth module, or a Wi-Fi module, or a Near Field Communications (NFC) module. The internal wireless communications module is configured to receive data representing an unlock message from an external wireless communications module (of a corresponding type, e.g., Bluetooth, Wi-Fi, NFC, etc.) to switch the state of the internal wireless communications module from a locked state to an unlocked state, or from the locked state to the unlocked state. The internal wireless communications module sends corresponding signals representing the selected locked state or unlocked state to the microprocessor, which controls the power controller to drive the actuator (210) to its corresponding locked state or unlocked state. As mentioned hereinbefore, the locked state of the actuator (210) can be the de-energised or de-electrified state, i.e., with no electrical current powering the actuator (210), so when no power is supplied to the actuator (210), the actuator portion (210) is in the locked state: to have the locking portion (200) in its unlocked state, the actuator (210) requires electrical power from the wiring (108) and the battery (704) via the controller (702). Thus, the locking portion (200) is naturally locked, and it cannot be unlocked if there is no electrical power, e.g., if the battery (704) is absent, if the battery (704) is flat, or if the wiring (108) is damaged, which improves the security of the lock. The actuator (210) may include a control processor or electronic code lock that controls the actuator (210) to operate only if a unique preselected control authentication signal or code is received from the controller (702) to mitigate unauthorised activation or hacking of the actuator (210).

As shown in FIG. 7, the apparatus (100) can form part of a system (700) that includes the apparatus (100) and an external controller (708) that communicates wirelessly with the controller (702) to send the unlock message to switch the controller state from the locked state to the unlocked state. The external controller (708) may also send a lock message to switch the controller state to the locked state. The external controller (708) includes the external wireless communications module. The external wireless communications module and the internal wireless communications module are configured to use authenticated encrypted messages that are decrypted by the controller (702) using decryption keys to limit the controller (702) receiving or switching state based on wireless messages received from other devices, i.e., unauthorised devices. In embodiments, the external controller (708) can be a smart phone with the appropriate wireless communications module, including firmware and/or software that includes matching encryption keys to those in the controller (702), thus allowing the encrypted messaging described hereinbefore.

The external controller (708) may be configured to generate the unlock message that controls the controller (702), on receipt of the message, to move to the unlocked state, and thus activate and unlock the actuator (210). The external controller (708) may be configured to transmit the unlock message when the external controller (708) is within a selected range of the internal wireless communications module in the controller (702), with the selected range depending on the particular shared communications protocol, e.g., Bluetooth, Wi-Fi, NFC, etc., which may include a determination of signal strengths and/or proximity appropriate to the protocol such that the controller (702) moves to the unlocked state when the external controller (708) is within the selected range. The range may be selected to be at least contact (i.e., zero range, touching the frame (102), the handlebar (402) or the display), or at least 1 mm, or at least 10 mm, or at least 100 mm, or at least 1 m, or at least 5 m, or at least 10 m, depending on the application. The selected range may be selected by selecting a type of protocol, and/or by selecting a range-defining parameter in one or both of the internal wireless communication module and the external wireless communication module.

The apparatus (100) may include a manual key-operated lock that can activate the actuator (210) and/or the locking portion (200), e.g., for use when the external controller (708) is inoperable or unavailable—i.e., the key-operated lock can be a back-up unlocking mechanism. The key-operated lock can include a tumbler mounted into the frame (102), e.g., into the tamper-resistant cover (410) on the underside of the handlebars (402). When operated using a matching manual key, the tumbler can: (i) operate a mechanical switch in the locking portion (200) to electrically connect the actuator (210) to power, and thus to unlock the locking portion (200); (ii) operate a mechanical switch connected to the controller (702) so that the controller (702) switches its state from the locked state to the unlocked state; and/or (iii) operate a mechanical mechanism to pull the latch bolt (202) out of the slot (312).

The electrical system of the apparatus (100) can include a disconnect detection mechanism to detect electrically when the retaining portion (106) is disconnected—including by cutting the retaining portion (106), or damaging the retaining portion (106) or locking portion (200). The disconnect detection mechanism includes electrical connections forming a conductive loop through the retaining portion (106) from the locking portion (200) to the stopper portion (304) or the exit (406): this conductive loop is broken when the retaining portion (106) is disconnected, and the controller (702) monitors electrical current flow (directly or indirectly) through the conductive loop, and generates an alert signal when the electrical current flow stops. The controller (702) can be configured to respond to the alert signal by sending an alert message to the external controller (708) to alert the user. The controller (702) can be configured to respond to the alert signal by disabling electrical functions of the item, e.g., drive functions of a scooter or bicycle.

The disconnect detection mechanism includes:
a. a first electrical contact (e.g., a sprung copper contact) from a first internal wire that touches the retaining portion (106) when it is in its locked position in the entrance (212);
b. an electrically conductive path including the retaining portion (106), the tethering portion (104) attached thereto, and the stopper portion (304) attached thereto;
c. a second electrical contact from a second internal wire that touches the stopper portion (304) at a plurality of its positions in the stopper tunnel (412)—because the stopper position in the locked condition will depend on the length of the tethering portion (104) required for the object—and the second electrical contact can include a loose wire that extends or extrudes as the stopper portion (304) moves up the stopper tunnel (412) from the stored position (304A); and
d. the controller (702) connected to the first internal wire and the second internal wire to monitor current flow around the conductive loop.

The apparatus (100) can be manufactured by the following method:
a. boring, routing or drilling the entrance (212) into the frame (102), optionally including inserting and affixing a pipe defining the inner sides of the entrance (212);
b. boring, routing or drilling the opening in the frame (102) to receive the locking portion (200);
c. affixing the locking portion (200) into the opening by adhesion, mechanical fasters (e.g., screws or clips), welding and/or brazing;
d. covering the opening with the tamper-resistant cover (410), and affixing the cover over the opening by adhesion, mechanical fasters (e.g., screws or clips), welding and/or brazing;
e. boring, routing or drilling the stopper tunnel (412) in the frame (102), e.g., in the stem;
f. boring, routing or drilling the restriction hole (408) in the frame (102), e.g., in the stem or the handlebars, at the exit or upper end of the exit tunnel (504) optionally including strengthening the restriction hole (408) with a washer or plate having a central hole defining an aperture of the restriction hole (408);
g. boring, routing or drilling the exit tunnel (504) and the exit (406) in the frame (102), e.g., in the handlebars, on the exit side of the restriction hole (504);
h. assembling the electrical system of the apparatus (100) into the frame (102) and electrically connecting the electrical system;
i. threading or passing the tethering portion (104) through the restriction hole (504);
j. attaching the stopper portion (304) to the proximal end (306) of the tethering portion (104) on the inner side of the restriction hole (504); and
k. attaching the retaining portion (106) to the distal end (302) of the tethering portion (104) on the outer side of the restriction hole (504).

The frame is locked to the object by the following method:
a. providing the apparatus (100) in the stored state, i.e., with the tethering portion (100) at the storage location (104A) in the frame (102);
b. allowing the frame (102) with the apparatus (100) to be placed adjacent the object to be secured to it;
c. allowing the tethering portion (104) to be extracted from the frame (102);
d. allowing the tethering portion (104) to extend around the object by its natural transverse flexibility;
e. the entrance (102) receiving the retaining portion (106);
f. the retainer head (314) pressing against the latch bolt (202) which is in the locked state because the locking portion (200) is in the locked state, i.e., the spring (214) is pressing the latch bolt (202) into the entrance (212);
g. the camming face (320) pushing and sliding away the angled face (206) of the latch bolt (202) to push the retainer head (314) past the latch bolt (202), until the latch bolt (212) pushes back into the slot (312) by the force of the spring (214), thus locking the retaining portion (106) into the locking portion (200);
h. the external controller (708) and/or a user control on the item (which may be a vehicle), e.g., a manual control, sending a signal to the controller (702) to lock any motor functions of the vehicle, and to control the display (706) to indicate the locked state;
i. the locking portion (200) and the item remaining in respective locked states until the external controller (708) returns within the selected range of the controller (702).
j. if automatic unlocking is enabled in settings in the controller (702), the controller (702) detects the external controller (708) via communications with the external wireless communications module, and determines that the external controller (708) is within the selected range;
k. the controller (702) may be configured to switch directly to its unlocked state or it may be configured to wait for a confirmatory input from a user input on the item, e.g., manual control of the vehicle, to confirm the automatic unlocking, and thus move to the unlocked state—in embodiments, pulling on a brake lever can generate the confirmatory input for the controller (702);
l. if automatic unlocking is not enabled in the controller (702), the external controller (708) requires a user input to generate the wireless unlock signal for the controller (702)—the user input can be a manual input or a voice input detected by the external controller (708), and/or optionally a code input into the item which may include a touch input and/or an audio input that is authenticated by the external controller (708) or the controller (702), and the controller (702) controls the actuator (210) to move to the unlocked state; and
m. the actuator (210) holding the locking portion (200) in the unlocked state allowing removal of the retaining portion (106) from the locking portion (200), and the stopper portion (304) and proximal end (306) of the tethering portion (104) being attracted by gravity down a portion of the frame (102) to draw the tethering portion (104) back into the frame (102).

The confirmatory input may be a combination code generated by user operation of operational input controls of the item: i.e., input controls also used for operation of the item (e.g. a vehicle), the operational input controls can include: throttle up, throttle down, brake on, brake off, vehicle turn on, vehicle turn off, frame fold, frame unfold. The operational input controls can generate respective input signals for the controller (702), including from electronic sensors attached to the operational input controls, and the controller (702) is configured to receive a time series of these input signals and compare this series to a stored passcode representing a preselected unlock series of signals. These input signals may also be generated by general operation of the throttle, the brake, an accessible button, touch screen display or keypad, or audio input to a microphone. If the stored passcode matches the time series of operational input signals, the controller (702) is configured to active the actuator (210), thus unlocking the lock. The combination code may also be used without the wireless unlock signal, e.g., for use when the external controller (708) is inoperable or unavailable—i.e., the confirmatory input can be a back-up unlocking mechanism. When operating the operational controls, the controller (702) may be configured to generate corresponding visible features on the display (706) to provide feedback regarding whether the operated controls have generated respective signals or not, thus assisting efficient operation by the user.

The tethering portion (104) and the retaining portion (106) may be safe because they are retained in the frame (102) while unlocked, and are not therefore easily caught in the wheels or control of the item. As mentioned hereinbefore, the locking portion (200) and the tethering portion (104) may be located at an advantageous height for locking to many secure objects, including poles, fences, bike rails, and posts, and the locking act can be performed at hand level, to mitigate excessive bending or kneeling, and the item can be held upright by the connection of its upper portion to the object, e.g., to stop the scooter or like falling over onto the ground.

### INTERPRETATION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. An apparatus for locking a frame to an object, the apparatus including:
a tethering portion that is stored inside the frame, and that extends around the object when it is partially removed from inside the frame;
a retaining portion secured to a distal end of the tethering portion; and
a locking portion mounted inside the frame for receiving the retaining portion to lock the distal end of the tethering portion in the frame.

2. The apparatus of claim 1, wherein the locking portion includes an actuator that unlocks the tethering portion when the actuator is activated.

3. The apparatus of claim 2, further including a controller that activates the actuator.

4. The apparatus of claim 1, further including a stopper portion at a proximal end of the tethering portion for attaching the proximal end of the tethering portion to the frame.

5. The apparatus of claim 1, further including an exit tunnel projecting into the frame that provides a storage alcove for the retaining portion in a storage condition.

6. A method for locking a frame to an object, the method including:
partially removing a tethering portion from inside the frame;
tethering the tethering portion around the object; and
locking the tethering portion.

7. The method of claim 6, further including unlocking the tethering portion by activating an actuator.

8. The method of claim 7, further including activating the actuator by an integrated electronic controller receiving an unlock message.

9. The method of claim 6, wherein a retaining portion is secured to a distal end of the tethering portion and further including storing the retaining portion in the frame in a storage condition.

10. A method for manufacturing a locking apparatus, including:
forming a stopper tunnel in the frame to store a tethering portion;
forming an exit in the frame to draw the tethering portion around an object; and
forming an entrance in the frame to lock the tethering portion in the frame.

11-12. (canceled)

13. The apparatus of claim 1, further including an integrated electronic controller that unlocks the locking portion to release the retaining portion on receipt of an unlock message from an external controller that communicates wirelessly with the integrated electronic controller.

14. The apparatus of claim 13, wherein the unlock message is associated with the external controller moving within a selected range of the integrated electronic controller.

15. The apparatus of claim 13, further including a key-operated lock that is also capable of unlocking the locking portion.

16. The apparatus of claim 15, wherein the key-operated lock includes a tumbler mounted to the frame.

17. The apparatus of claim 1, further including a stopper portion at a proximal end of the tethering portion for attaching the proximal end of the tethering portion to the frame, and further including an exit tunnel projecting into the frame that provides a storage alcove for the retaining portion in a storage condition.

18. The apparatus of claim 1, wherein the retaining portion includes a slot for receiving a latch bolt of the locking portion.

19. The apparatus of claim 1, wherein the retaining portion includes a gripping portion that is secured to the distal end of the tethering portion.

20. The apparatus of claim 1, wherein the retaining portion is stored adjacent to an exit aperture in the frame when the apparatus is in an unlocked state and is inserted into an entrance aperture in the frame when the apparatus is in a locked state.

21. The apparatus of claim 20, wherein the locking portion is located adjacent to the entrance aperture in the frame.
